(19) United States
(12) Patent Application Publication
(10) Pub. No.: US 2026/0148432 A1
(43) Pub. Date: May 28, 2026

(54) METHOD, APPARATUS, DEVICE, AND STORAGE MEDIUM FOR IMAGE GENERATION

(71) Applicants: Beijing Youzhuju Network Technology Co., Ltd., Beijing (CN); Lemon Inc., Grand Cayman (KY)

(72) Inventors: Jian HAN, Beijing (CN); Jinlai LIU, Beijing (CN); Yi JIANG, Los Angeles, CA (US); Bin YAN, Beijing (CN); Yuqi ZHANG, Beijing (CN); Zehuan YUAN, Beijing (CN); Bingyue PENG, Los Angeles, CA (US)

(21) Appl. No.: 19/324,710

(22) Filed: Sep. 10, 2025

(30) Foreign Application Priority Data
Nov. 27, 2024 (CN) 202411722468.1

(51) Int. Cl. G06T 11/00; G06V 10/764; G06V 10/77

(52) U.S. Cl. CPC G06T 11/00; G06V 10/764; G06V 10/7715

(57) ABSTRACT

Embodiments of the disclosure provide a method, an apparatus, a device, a storage medium, and a program product for image generation. The method includes: generating a feature embedding by a trained machine learning model and based on at least a text prompt for image generation; determining by a trained classifier model, at least one visual feature unit from a visual feature codebook to form a visual feature map matching the feature embedding, determining, by each classifier in the classifier model, a value of one bit position in the bit sequence respectively, and obtaining the visual feature unit from the visual feature codebook based on the determined value of the respective bit position in the bit sequence; and generating a predicted image matching the text prompt based on the visual feature map.

### CROSS-REFERENCE

The present application claims priority to Chinese Patent Application No. 202411722468.1, filed on Nov. 27, 2024, and entitled “METHOD, APPARATUS, DEVICE, AND STORAGE MEDIUM FOR IMAGE GENERATION”, which is incorporated herein by reference in its entirety.

### FIELD

Example embodiments of the present disclosure generally relate to the field of computer technologies, and in particular, to a method, an apparatus, a device, and a computer-readable storage medium for image generation.

### BACKGROUND

Visual generation techniques have recently achieved rapid development, enabling high-quality and high-resolution image and video synthesis. Text-to-image generation is one of the most challenging tasks because it requires complex language specification and scene creation. At present, visual generation is mainly divided into two main methods: the diffusion model and the autoregressive model. In order to improve the image generation quality, the models used are usually designed to be more complex, and the number of model parameters is very large, which brings challenges to the model training and computing efficiency, parameter storage, and the like. How to improve the model efficiency as much as possible while ensuring the visual generation quality has always been a concern.

### SUMMARY

In a first aspect of the present disclosure, a method for image generation is provided. The method includes: generating a feature embedding by a trained machine learning model and based on at least a text prompt for image generation; determining, by a trained classifier model, at least one visual feature unit from a visual feature codebook to form a visual feature map matching the feature embedding, where each visual feature unit in the visual feature codebook is indexed by a bit sequence, and where determining each visual feature unit matching the generated feature embedding from the visual feature codebook includes: determining, by each classifier in the classifier model, a value of one bit position in the bit sequence respectively, and obtaining the visual feature unit from the visual feature codebook based on the determined value of the respective bit position in the bit sequence; and generating a predicted image matching the text prompt based on the visual feature map.

In a second aspect of the present disclosure, an apparatus for image generation is provided. The apparatus includes: a feature embedding generation module configured to generate a feature embedding by a trained machine learning model and based on at least a text prompt for image generation; a visual feature unit determination module configured to determine, by a trained classifier model, at least one visual feature unit from a visual feature codebook to form a visual feature map matching the feature embedding, and where each visual feature unit in the visual feature codebook is indexed by a bit sequence, where determining each visual feature unit matching the generated feature embedding from the visual feature codebook includes: determining, by each classifier in the classifier model, a value of one bit position in the bit sequence respectively, and obtaining the visual feature unit from the visual feature codebook based on the determined value of the respective bit position in the bit sequence; and a predicted image generation module configured to generate a predicted image matching the text prompt based on the visual feature map.

In a third aspect of the present disclosure, an electronic device is provided. The device includes at least one processor; and at least one memory coupled to the at least one processor and storing instructions executable by the at least one processor, the instructions, when executed by the at least one processor, causing the electronic device to perform the method of the first aspect.

In a fourth aspect of the present disclosure, a computer-readable storage medium is provided. The medium has a computer program stored thereon, which, when executed by a processor, causes the processor to perform the method of the first aspect.

In a fifth aspect of the present disclosure, a computer program product is provided. The computer program product includes a computer program, which, when executed by a processor, causes the processor to perform the method of the first aspect.

It should be appreciated that the content described in this section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The foregoing and other features, advantages, and aspects of the embodiments of the present disclosure become more apparent with reference to the following detailed description and in conjunction with the drawings. In the drawings, the same or similar reference numerals denote the same or similar elements.

FIG. 1 shows a schematic diagram of an example environment in which embodiments of the present disclosure may be implemented;

FIG. 2 shows a schematic diagram of an index-wise discrete tokenizer;

FIG. 3 shows an inference process of a visual generation model according to some embodiments of the present disclosure;

FIG. 4 shows a schematic diagram of indexing a visual feature unit by a bit sequence according to some embodiments of the present disclosure;

FIG. 5 shows a training process of a machine learning model and a classifier model according to some embodiments of the present disclosure;

FIG. 6 shows a schematic diagram of generating a sample residual feature map according to some embodiments of the present disclosure;

FIG. 7 shows a flowchart of a method for image generation according to some embodiments of the present disclosure;

FIG. 8 shows an example structural block diagram of an apparatus for image generation according to some embodiments of the present disclosure; and

FIG. 9 shows a block diagram of an electronic device in which one or more embodiments of the present disclosure may be implemented.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and the embodiments of the present disclosure are only used for illustrative purposes, and are not used to limit the protection scope of the present disclosure.

In the description of the embodiments of the present disclosure, the term “include/comprise” and similar terms thereof should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other definitions, either explicit or implicit, may be included below.

It may be understood that the data involved in the technical solution (including but not limited to the data itself, acquisition or use of the data) should comply with requirements of corresponding laws, regulations, and related provisions.

It may be understood that before the use of the technical solutions disclosed in the embodiments of the present disclosure, the user should be informed of the type, range of use, use scenarios, etc., of personal information involved in the present disclosure and the authorization of the user should be obtained in an appropriate manner in accordance with relevant laws and regulations.

For example, in response to receiving an active request from a user, prompt information is sent to the user to clearly prompt the user that the requested operation will require access to and use of the user's personal information, so that the user may independently choose, based on the prompt information, whether to provide the personal information to software or hardware, such as an electronic device, an application, a server, or a storage medium, that performs the operations of the technical solutions of the present disclosure.

As an optional but non-restrictive implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative, and does not limit the implementations of the present disclosure. Other manners that satisfy the relevant laws and regulations may also be applied to the implementations of the present disclosure.

As used herein, the term “model” may learn the correlation between corresponding input and output from training data, so that the corresponding output may be generated for given input after the training is completed. The generation of the model may be based on machine learning techniques. Deep learning is a machine learning algorithm that uses multiple layers of processing units to process input and provide corresponding output. A neural network model is an example of a model based on deep learning. Herein, a “model” may also be referred to as a “machine learning model”, a “learning model”, a “machine learning network”, or a “learning network”, which terms are used interchangeably herein.

A “neural network” is a machine learning network based on deep learning. A neural network may process input and provide corresponding output, and generally includes an input layer and an output layer, and one or more hidden layers between the input layer and the output layer. Neural networks used in deep learning applications typically include many hidden layers, thereby increasing the depth of the network. The layers of the neural network are connected in sequence, so that the output of the previous layer is provided as the input of the next layer, where the input layer receives the input of the neural network, and the output of the output layer is used as the final output of the neural network. Each layer of the neural network includes one or more nodes (also referred to as processing nodes or neurons), each of which processes the input from the previous layer.

Generally, machine learning may roughly include three stages, namely, a training stage, a testing stage, and an application stage (also referred to as an inference stage). In the training stage, a given model may be trained using a large amount of training data, and a parameter value is continuously updated iteratively until the model may obtain consistent inference that meets an expected target from the training data. Through training, the model may be considered to be capable of learning an association (also referred to as a mapping from input to output) from input to output from the training data. The parameter value of the trained model is determined. In the testing stage, a test input is applied to the trained model to test whether the model may provide a correct output, thereby determining the performance of the model. The testing stage may sometimes be integrated into the training stage. In the application or inference stage, the trained model may be used to process an actual model input based on the parameter value obtained through training, and determine a corresponding model output.

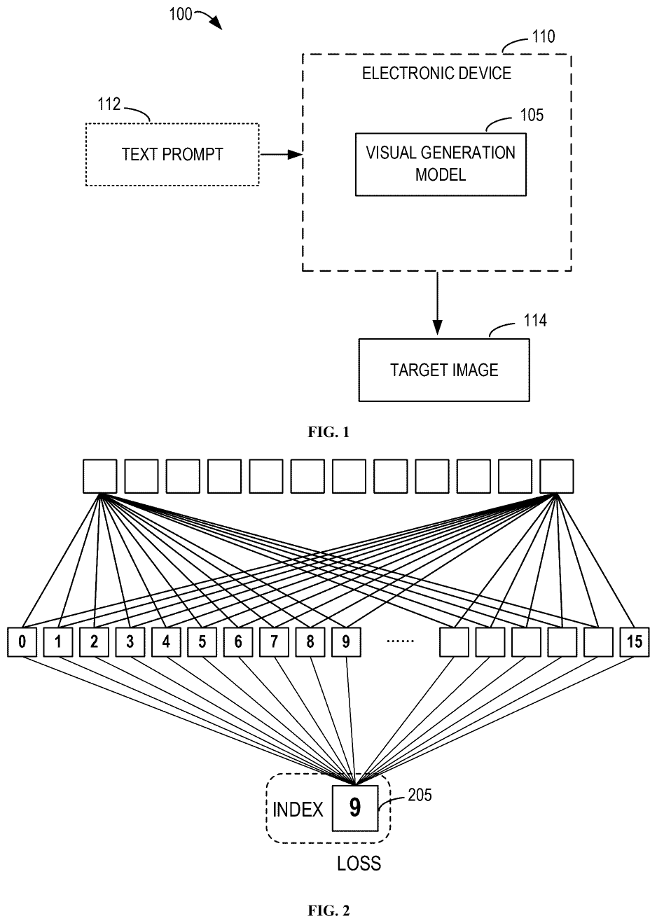

FIG. 1 shows a schematic diagram of an example environment 100 in which the embodiments of the present disclosure may be implemented. In the environment 100, an electronic device 110 applies a visual generation model 105 to perform image generation. The visual generation model 105 is configured to generate a target image 114. The visual generation model 105 is configured to process a text prompt 112 input by a user to generate the target image 114. In some embodiments, the text prompt 112 is used to guide the visual generation model 105 to generate an image of a specific object, for example, the text prompt 112 may be “please generate an image of a flower”.

In the environment 100, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination thereof, including accessories and peripherals of these devices or any combination thereof. In some embodiments, the electronic device 110 may also support any type of user-specific interface (such as a “wearable” circuit, etc.). The visual generation model 105 may, for example, be implemented in various types of computing systems/servers that may provide computing power, including but not limited to mainframes, edge computing nodes, computing devices in cloud environments, and so on.

It should be appreciated that the structures and functions of the elements in the environment 100 are described for illustrative purposes only, without suggesting any limitation to the scope of the present disclosure.

As mentioned above, the visual generation model mainly includes the diffusion model and the autoregressive model. The diffusion model is trained to reverse the forward path of data into random noise, and effectively generate images through a continuous denoising process. On the other hand, the autoregressive model uses the scalability and versatility of the language model, uses a visual tokenizer to convert an image into discrete tokens and optimize these tokens, thereby allowing the image to be generated by next-token prediction or next-scale prediction. When discrete tokens instead of continuous tokens are used, they exhibit poor reconstruction quality. In addition, the generated visual content is not as detailed as the content generated by the diffusion model. Due to the raster scan method of next-token prediction, inefficiency and latency in visual generation further exacerbate these problems.

In some solutions, the autoregressive model uses the powerful scaling capability of the language model, uses a discrete image tokenizer in combination with a transformer, and generates images based on the next-token prediction. The method based on vector quantization (VQ) uses vector quantization to convert image blocks into index-wise tokens, and uses a decoder-only transformer to predict the next token index. However, these methods are limited by the lack of scaling transformers and quantization errors, and cannot achieve performance comparable to that of diffusion models. Inspired by the global structure of visual information, the visual autoregressive model (VAR) redefines the autoregressive modeling of images as a next-scale prediction framework, significantly improving the generation quality and sampling speed.

The diffusion model has made rapid progress in all directions. The denoising learning mechanism and sampling efficiency have been continuously optimized to generate high-quality images. The latent diffusion model is the first model to propose diffusion modeling in the latent space instead of the pixel space.

The scaling law in the autoregressive language model reveals a power-law relationship between model size, dataset size, and computation and test set cross-entropy loss. These laws help predict the performance of larger models, enabling efficient resource allocation and continuous improvement without saturation. This inspires research on scaling in visual generation.

Recently, visual autoregressive modeling (VAR) has redefined autoregressive learning on images as coarse-to-fine “next-scale prediction”. VAR takes advantage of the scaling properties of language models, can optimize previous scaling steps at the same time, and also benefits from the advantages of diffusion models. However, the index-wise discrete tokenizer used in autoregressive models or visual autoregressive models faces significant quantization errors in the case of limited codebook size, especially in high-resolution images, making it difficult to reconstruct fine-grained details.

FIG. 2 shows a schematic diagram of an index-wise discrete tokenizer. As shown in FIG. 2, the index-wise discrete tokenizer may predict the index (represented by an integer) of the visual feature unit corresponding to the continuous feature embedding in the codebook. In the example of FIG. 2, there are 16 indices in total, and index 205 (that is, integer 9) is determined. In the generation stage, the index-wise token may be affected by fuzzy supervision, resulting in loss of visual details and local distortion. In addition, the training-testing difference of teacher-forcing training inherent in language models amplifies the cumulative error of visual details. These challenges make index-wise tokens an important bottleneck for autoregressive models.

To solve the above problem, an embodiment of the present disclosure proposes a solution for image generation. Specifically, a feature embedding is generated by a trained machine learning model based on at least a text prompt for image generation; at least one visual feature unit is determined by a trained classifier model from a visual feature codebook to form a visual feature map matching the feature embedding, and where each visual feature unit in the visual feature codebook is indexed by a bit sequence, and determining each visual feature unit matching the generated feature embedding from the visual feature codebook includes: determining, by each classifier in the classifier model, a value of one bit position in the bit sequence respectively, and obtaining the visual feature unit from the visual feature codebook based on the determined value of the respective bit position in the bit sequence; and a predicted image matching the text prompt is generated based on the visual feature map.

According to the solution of the present disclosure, the visual feature unit in the visual feature map may be indexed by the bit sequence, and each classifier in the classifier model respectively determines the value of one bit position in the bit sequence. Such a binary classifier may not only effectively perform classification and effectively retrieve a matching visual feature unit from the codebook, but also simplify parameters of the classifier and greatly reduce the complexity of the classifier model. Therefore, while ensuring the classification accuracy, the efficiency of model training and model inference may also be improved, and the memory requirement for parameter storage may also be reduced. On the other hand, such a classifier model may support an effective increase in the codebook size of the visual feature codebook without causing excessive parameters of the classifier model due to an excessively large codebook. Further, based on such a classifier model, the feature expression capability in the visual generation process may be improved, the image reconstruction accuracy may be improved, and the diversity and quality of the generated image may be enhanced.

Some example embodiments of the present disclosure are described below with continued reference to the drawings.

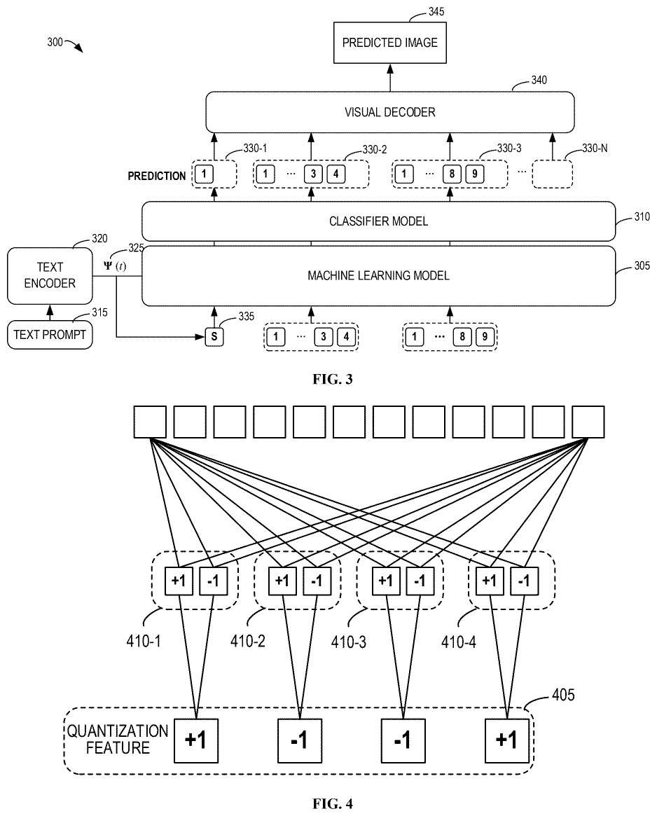

FIG. 3 shows an inference process 300 of the visual generation model 105 according to some embodiments of the present disclosure. As shown in FIG. 3, the visual generation model 105 includes a machine learning model 305 and a classifier model 310. In the inference process of visual generation, a feature embedding (not shown in the figure) may be generated using the trained machine learning model 305 based on at least a text prompt 315 for image generation. In some examples, the machine learning model 305 may be a content generation model, which may determine an intention of content generation based on a model input, thereby generating content that meets the expectation. In some embodiments, the machine learning model 305 may be constructed based on a transformer model, such as a VAR transformer. The machine learning model 305 may include a plurality of repeated blocks, such as a self-attention block, a cross-attention block, a feedforward neural network (FFN) layer, and so on. In some embodiments, the text prompt 315 is input into a text encoder 320, and a text embedding representation 325 (represented by P(t)) may be obtained. The text embedding representation 325 instructs the machine learning model 305 to generate the feature embedding through a cross-attention mechanism.

After the machine learning model 305 generates the feature embedding, the trained classifier model 310 is used to determine the visual feature unit based on the generated feature embedding. Specifically, the classifier model 310 determines at least one visual feature unit from the visual feature codebook to form a visual feature map 310 (for example, including visual feature maps 330-1 to 330-N, which are collectively referred to as visual feature maps 330 for ease of description) matching the feature embedding. The visual feature codebook includes a plurality of visual feature units, each of which may be regarded as a vectorized feature of a certain dimension.

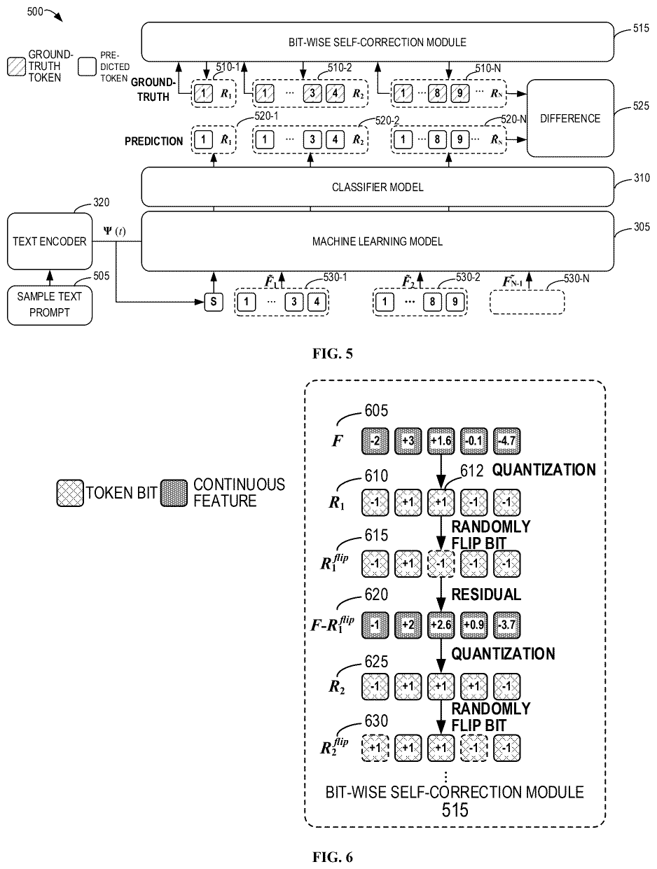

In an embodiment of the present disclosure, each visual feature unit in the visual feature codebook may be indexed by a bit sequence. The indexing of the visual feature unit by the bit sequence will be described below with reference to FIG. 4, which is a schematic diagram of indexing a visual feature unit by a bit sequence according to some embodiments of the present disclosure. In the example of FIG. 4, four classifiers 410-1 to 410-4 may determine, from the visual feature codebook, that the quantization feature 405 corresponding to one visual feature unit is {+1, −1, −1, +1}, where +1 indicates bit 1, and −1 indicates bit 0, therefore, the last four bits of the bit sequence of the visual feature unit are 1001. The corresponding visual feature unit may be obtained based on the bit sequence. The number of bit values of the bit sequence of each visual feature is related to the size of the visual feature codebook (for example, related to the total number of visual feature units included in the codebook). For example, if the size of the codebook is 2³², the number of bit values of the bit sequence is 32.

In the related art, a transformer predicts a label (which may also be referred to as an index in integer form) yₖ ∈[0, V^{d})^{h}^{ₖ}^{×w}^{ₖ} of the visual feature unit, and optimizes the target through the cross-entropy loss, where V_{d} is the size of the codebook. The label is directly calculated by the classifier with V_{d} classes. In the case that the size of the codebook is very large, for example, V_{d}=2³² and h=2048, the traditional classifier used in the related art requires a weight matrix W∈ [symbol] of trillions of parameters, which will exceed the limit of the current computing resources. The prediction of th at efIthe visual feature unit in the related art may be as follows:

$${y}_{k} ( m , n ) = {{\sum }^{d - 1}}_{p = 0} {𝕝}_{{R}_{k} ( m , n , p ) > 0} \cdot {2}^{p} \qquad ( 1 )$$

where yₖ (m, n) represents the label, Rₖ (m, n, p) represents the visual feature unit, m∈[0, hₖ), and m ∈[0, wₖ). Due to the characteristics of the quantization method, slight disturbances to those features close to zero will cause significant changes in the label. Therefore, it is difficult to optimize the index-wise classifier used in the related art.

Continuing to refer to FIG. 3, each classifier in the classifier model 310 may be used to determine a value (for example, bit 0 or bit 1) of one bit position in the bit sequence. In some embodiments, the number of classifiers in the classifier model 310 is the same as the number of bits of the bit sequence, and the classifiers respectively correspond to the bit positions in the bit sequence. For example, if the number of bits of the bit sequence is 32, the number of classifiers is 32. Each classifier corresponds to one bit position in the bit sequence. The 32nd classifier is used as an example. The 32nd classifier is configured to predict a value of the 32nd bit in the bit sequence. Compared with a traditional classifier that has V_{d} categories, d binary classifiers in the classifier model 310 proposed in this application may determine the value of each bit position, where d=log₂(V_{d}). In this way, by reducing the number of classifiers, computing resources may be saved, and the stability of classifier calculation may be enhanced.

In some embodiments, the classifiers in the classifier model 310 are configured to determine the values of the bit positions in the bit sequence in parallel. In some examples, the value of each bit position may be determined by predicting whether each bit position in the bit sequence is a positive number or a negative number. For example, if a bit position is predicted to be a positive number, the value of the bit position is bit 1. If a bit position is predicted to be a negative number, the value of the bit position is bit 0. In this way, through parallel computing, the computing speed may be improved, and the reliability and stability of computing may be improved.

In some embodiments, the generation of the feature embedding and the determination of the visual feature map may be iteratively performed at a plurality of scales. For a given scale of the plurality of scales, the machine learning model 305 may be used to generate a feature embedding for the given scale based on the text prompt 315 and a visual feature map determined for at least one scale before the given scale. In some examples, first, the text embedding representation 325 may be mapped to a sequence start token 335 (represented by SOS, SOS ∈ [symbol] ), where h is a hidden dimension of the machine learning model 305, and the machine learning model 305 may generate a visual feature map of a minimum scale based on the sequence start token. For the given scale after the minimum scale, the machine learning model 305 may be used to generate the feature embedding for the given scale based on the text prompt 315 and the visual feature map determined for the at least one scale before the given scale. The generation process of the feature embedding for the given scale may be as follows:

$$p ( {R}_{1} , … , {R}_{K} ) = {{\prod }^{K}}_{k = 1} p ( {R}_{k} \vert {R}_{1} , … , {R}_{k - 1} , Ψ ( t ) ) , \qquad ( 2 )$$

where Ψ(t) represents the text embedding representation 325 for the text prompt 315, (R₁, . . . , Rₖ₋₁) represents the visual feature map determined for the at least one scale before the given scale, and Rₖ represents the feature embedding for the given scale. (Rₖ|R₁, . . . , Rₖ₋₁, Ψ(t)) represents a prefix context for predicting Rₖ.

In some embodiments, for the given scale of the plurality of scales, the classifier model 310 may be used to determine, from the visual feature codebook, a number of visual feature units corresponding to the given scale, to obtain the visual feature map for the given scale. The visual feature map 330-2 is used as an example. The size corresponding to the visual feature map 330-2 is 2×2, that is, the visual feature map 330-2 includes four visual feature units in total. Therefore, the classifier model may be used to determine the number (that is, four) of visual feature units corresponding to the given scale (for example, 2×2) from the visual feature codebook, to obtain the visual feature map 330-2 for the given scale.

In some embodiments, the visual feature map includes a plurality of residual feature maps of the plurality of scales. The plurality of residual feature maps of the plurality of scales may be respectively sampled to a reference scale of the plurality of scales based on the reference scale, to obtain a plurality of sampled residual feature maps. A target feature map is generated by aggregating the plurality of sampled residual feature maps, and the predicted image is decoded from the target feature map. The process of sampling and aggregating the residual feature maps may be as follows:

$${F}_{k} = {{\sum }^{k}}_{i = 1} up ( {R}_{i} , ( h , w ) ) \qquad ( 3 )$$

where up (Rᵢ, (h, w)) represents bilinear upsampling of the plurality of residual feature maps of the plurality of scales, and Fₖ is the cumulative sum of upsampled R_{≤k}, that is, the target feature map. The predicted image 345 may be decoded from the target feature map by a visual decoder 340. The visual decoder 340 may decode the encoded signal in the target feature map to obtain the predicted image 345. In some embodiments, the visual decoder 340 may be trained by using the difference between the predicted image 345 and a ground-truth image as a training target, and the training target is configured to reduce or minimize the difference between the predicted image 345 and the ground-truth image.

In some embodiments, to predict the visual feature map (represented by Rₖ) of the kth scale, the target feature map of the previous scale k−1 may be downsampled, to predict the visual feature map of the kth scale in parallel. The downsampling process may be as follows:

$${\tilde{F}}_{k - 1} = down ( {F}_{k - 1} , ( {h}_{k} , {w}_{k} ) ) , \qquad ( 4 )$$

where down(Fₖ₋₁, (hₖ, wₖ)) represents downsampling of the target feature map of the previous scale k−1, and the spatial sizes of \tilde{F}ₖ₋₁ and Rₖ are both (hₖ, wₖ).

The training process of the machine learning model and the classifier model is described below with reference to FIG. 5. FIG. 5 shows a training process 500 of the machine learning model 305 and the classifier model 310 according to some embodiments of the present disclosure. As shown in FIG. 5, first, training data for training the machine learning model 305 and the classifier model 310 may be obtained, where the training data includes a sample image (not shown in the figure) and a sample text prompt 505 describing the sample image. A plurality of sample residual feature maps 510 (for example, including sample residual feature maps 510-1 to 510-N, which are collectively referred to as sample residual feature maps 510 for ease of description) of a plurality of scales may be generated based on the sample image. In some embodiments, the plurality of sample residual feature maps of the plurality of scales may be generated by respectively performing random flipping on bit values in a sample residual feature map of the sample image, where the sample residual feature map includes binary bit values. The random flipping may be performed to flip a bit value in the sample residual feature map from +1 to −1, or from −1 to +1.

Next, the machine learning model 305 to be trained and the classifier model 310 to be trained may be used to generate a plurality of predicted residual feature maps 520 (for example, including predicted residual feature maps 520-1 to 520-N, which are collectively referred to as predicted residual feature maps 520 for ease of description) of the plurality of scales based on the sample text prompt 505. Then, the machine learning model 305 and the classifier model 310 may be trained based on a predetermined training target, where the training target is configured to reduce or minimize a difference 525 between the plurality of sample residual feature maps 510 and the plurality of predicted residual feature maps 520. In some embodiments, the difference between the feature maps may be defined as, for example, the cross-entropy loss, the KL divergence loss, the mean squared error loss, or the like between the feature maps. The training target is achieved by defining a corresponding loss function and minimizing the loss function. The definition of a specific loss function is not limited in the embodiment of the present disclosure.

In some embodiments, a quantizer may be used to quantize a continuous feature into a discrete feature. Increasing the codebook size has great potential for improving the reconstruction and generation quality. However, directly increasing the codebook size in an existing quantizer will lead to a significant increase in memory consumption and computational burden. The present disclosure proposes a new bit-wise multi-scale residual quantizer. Given K scales, at the kth scale, the multi-scale residual quantizer may quantize the input continuous residual vector zₖ ∈ [symbol] into the binary output qₖ. The quantization process may be performed by using the following two methods:

$${q}_{k} = \{ \begin{matrix}sign ( {z}_{k} ) & if a first method is adopted \\ \frac{1}{\sqrt{d}} sign ( \frac{{z}_{k}}{\vert {z}_{k} \vert} ) & i f a second method is adopted\end{matrix} \qquad ( 5 )$$

where sign(⋅) is a sign function. To encourage the use of the codebook, an entropy loss function [symbol] = [symbol] [H(q(z))]−H[ [symbol] (q(z))] may be used, where H(⋅) represents entropy. To obtain the distribution of q(z), when the first method is used, it is necessary to calculate the similarity between the input z and the entire codebook, which may lead to high space and time complexity O(2^{d}). When the dimension d of the codebook increases (for example, increases to 20), a memory overflow problem may occur. Since the input and output of the second method are unit vectors, the second method may provide an approximate formula for the above entropy loss function, reducing the computational complexity to O(d). Therefore, even in the case that the codebook size is 2⁶⁴, the second method does not significantly increase memory consumption.

In some embodiments, the bit-wise self-correction module 515 may be used to process the plurality of sample residual feature maps 410. Since errors generated at a previous scale may propagate to a next scale, the bit-wise self-correction module 515 may be used to solve this problem. The processing process of the bit-wise self-correction module 515 is described below with reference to FIG. 6. FIG. 6 shows a schematic diagram of generating a sample residual feature map according to some embodiments of the present disclosure. In some examples, as shown in FIG. 6, a sample feature map 605 may be extracted from the sample image, and the sample feature map 605 may include a continuous feature. Then, the sample feature map 605 may be quantized into a first sample residual feature map 610 corresponding to a first scale (for example, a minimum scale) of the plurality of scales, the first sample residual feature map 610 includes binary bit values.

In some embodiments, the flipped sample residual feature map 615 corresponding to the first scale may be generated by performing random flipping on the bit values in the first sample residual feature map 610. In some examples, the bit values of the first sample residual feature map 610 may be flipped at a probability of 0% to 20%. Certainly, in other examples, any other appropriate flipping ratio may be configured. In the example in FIG. 6, the bit value +1 in the first sample residual feature map 610 is flipped to −1. Then, a second sample residual feature map corresponding to a scale other than the first scale in the plurality of scales may be generated based on at least a difference between the sample feature map 605 and the flipped sample residual feature map 615 corresponding to the first scale.

In some embodiments, the generation of the second sample residual feature map may be iteratively performed for the other scales in the plurality of scales. For the first round of a plurality of iteration rounds, a difference feature map 620 may be generated based on the difference between the sample feature map 605 and the flipped sample residual feature map 615 corresponding to the first scale. Then, the difference feature map 620 may be quantized into a second sample residual feature map 625, that is, a sample residual feature map corresponding to the scale of the first round.

In some embodiments, for a round after the first round in the plurality of iteration rounds, a difference feature map of the round may be generated based on a difference between a difference feature map obtained in the previous round and an flipped sample residual feature map obtained in the previous round, and the difference feature map of the round may be quantized into the second sample residual feature map corresponding to the scale of the round. The round after the first round being the second round is used as an example. A difference feature map (not shown in the figure) of the second round may be generated based on the difference between the difference feature map (that is, the difference feature map 620) obtained in the previous round and the flipped sample residual feature map (that is, the flipped sample residual feature map 630) obtained in the previous round. Then, the difference feature map of the second round may be quantized to obtain the second sample residual feature map corresponding to the scale of the second round.

Continuing to refer to FIG. 5, in some embodiments, the generation of the plurality of predicted residual feature maps 520 is iteratively performed at the plurality of scales. For a given scale of the plurality of scales, an flipped predicted feature map 530 (for example, including flipped predicted feature maps 530-1 to 530-N, which are collectively referred to as flipped predicted feature maps 530 for ease of description) for the given scale may be generated based on flipped sample residual feature maps corresponding to the given scale and at least one scale before the given scale. The process of generating the flipped predicted feature map 530 for the given scale may be as follows:

$${F}_{k}^{flip} = {{\sum }^{k}}_{i = 1} up ( {R}_{i}^{flip} , ( h , w ) ) \qquad ( 6 )$$

$${\tilde{F}}_{k} = down ( {F}_{k}^{flip} , ( {h}_{k + 1} , {w}_{k + 1} ) ) \qquad ( 7 )$$

where

$${R}_{i}^{flip}$$

represents the flipped sample residual feature maps corresponding to the given scale and the at least one scale before the given scale, \tilde{F}ₖ represents the flipped predicted feature map 530, and for the definitions of up(⋅) and down(⋅), see formula (3) and formula (4) above.

In some embodiments, after the flipped predicted feature map 530 for the given scale is generated, the predicted residual feature map for the given scale may be generated by inputting the sample text prompt and the flipped predicted feature map 530 for the given scale into the machine learning model 305. The process of generating the predicted residual feature map may be as follows:

$${R}_{k + 1} = quant ( down ( F - {F}_{k}^{flip} , ( {h}_{k + 1} , {w}_{k + 1} ) ) ) \qquad ( 8 )$$

where quant(⋅) represents a quantization operation, F represents the sample feature map or the difference feature map, and Rₖ₊₁ represents the predicted residual feature map of the given scale. According to the embodiment of the present disclosure, the predicted residual feature map of each scale has to experience random flipping of bits and recalculation of the predicted residual feature map. The machine learning model 305 uses the randomly flipped feature as input, taking into account errors in the prediction. In this way, errors in previous prediction may be fixed, and the training efficiency may be improved.

Different from the related art that may only generate an image with a fixed height-to-width ratio, the visual generation model proposed in the embodiment of the present disclosure may generate images with different height-to-width ratios. In some embodiments, a plurality of scales

$$\{ ( {h}_{1}^{r} , {w}_{1}^{r} ) , … , ( {h}_{K}^{r} , {w}_{K}^{r} ) \}$$

may be defined for each height-to-width ratio, where r represents the height-to-width ratio. Additionally, for different height-to-width ratios of the same scale k, it is necessary to keep the area of

$${h}_{k}^{r} \times {w}_{k}^{r}$$

approximately the same, to ensure that the training sequence lengths are approximately the same.

In some embodiments, two-dimensional rotary position encoding (RoPE2d) may be applied to the feature of each scale to preserve the intrinsic two-dimensional structure of the image. Additionally, learnable scale embeddings may be used to avoid confusion between features of different scales. In this way, images with different height-to-width ratios may be generated, and the flexibility of image generation may be improved.

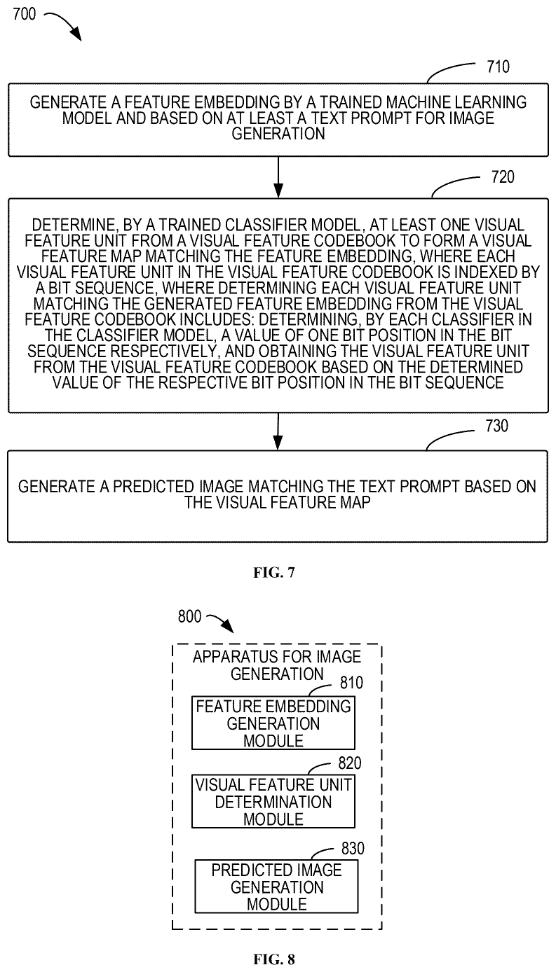

FIG. 7 shows a flowchart of an image generation method 700 according to some embodiments of the present disclosure. The method 700 may be implemented at the computing device 110 in FIG. 1. The method 700 is described with reference to the environment 100 in FIG. 1.

At block 710, the computing device 110 generates a feature embedding by a trained machine learning model and based on at least a text prompt for image generation.

At block 720, the computing device 110 determines, by a trained classifier model, at least one visual feature unit from a visual feature codebook to form a visual feature map matching the feature embedding, where each visual feature unit in the visual feature codebook is indexed by a bit sequence, and where determining each visual feature unit matching the generated feature embedding from the visual feature codebook includes: determining, by each classifier in the classifier model, a value of one bit position in the bit sequence respectively, and obtaining the visual feature unit from the visual feature codebook based on the determined value of the respective bit position in the bit sequence.

At block 730, the computing device 110 generates a predicted image matching the text prompt based on the visual feature map.

In some embodiments, the number of classifiers in the classifier model is the same as the number of bits of the bit sequence, and the classifiers respectively correspond to the respective bit positions in the bit sequence.

In some embodiments, the respective classifiers in the classifier model are configured to determine the values of the respective bit positions in the bit sequence in parallel.

In some embodiments, the generation of the feature embedding and the determination of the visual feature map are iteratively performed at a plurality of scales. Generating the feature embedding for a given scale of the plurality of scales includes: generating, by the machine learning model, the feature embedding for the given scale based on the text prompt and a visual feature map determined for at least one scale before the given scale. Determining the at least one visual feature unit for the given scale of the plurality of scales includes: determining, by the classifier model, a number of visual feature units corresponding to the given scale from the visual feature codebook to obtain the visual feature map for the given scale.

In some embodiments, the visual feature map includes a plurality of residual feature maps of the plurality of scales. Generating the predicted image matching the text prompt includes: sampling, based on a reference scale of the plurality of scales, the plurality of residual feature maps of the plurality of scales to the reference scale respectively, to obtain a plurality of sampled residual feature maps; generating a target feature map by aggregating the plurality of sampled residual feature maps; and decoding the predicted image from the target feature map.

In some embodiments, the machine learning model and the classifier model are trained by: obtaining training data including a sample image and a sample text prompt describing the sample image; generating a plurality of sample residual feature maps of a plurality of scales by respectively performing random flipping on a bit value in a sample residual feature map of the sample image, the sample residual feature map including binary bit values; generating a plurality of predicted residual feature maps of the plurality of scales based on a predetermined training objective by the machine learning model to be trained and the classifier model to be trained based on the sample text prompt; and training the machine learning model and the classifier model, the training objective being configured to reduce or minimize a difference between the plurality of sample residual feature maps and the plurality of predicted residual feature maps.

In some embodiments, generating the plurality of sample residual feature maps includes: extracting a sample feature map from the sample image; and quantizing the sample feature map into a first sample residual feature map corresponding to a first scale of the plurality of scales; generating an flipped sample residual feature map corresponding to the first scale by performing random flipping on a bit value in the first sample residual feature map; and generating a second sample residual feature map corresponding to a scale other than the first scale in the plurality of scales based on at least a difference between the sample feature map and the flipped sample residual feature map corresponding to the first scale.

In some embodiments, the generation of the second sample residual feature map is iteratively performed for other scales in the plurality of scales, and where generating the second sample residual feature map for a first round of a plurality of iteration rounds includes: generating a difference feature map based on the difference between the sample feature map and the flipped sample residual feature map corresponding to the first scale; and quantizing the difference feature map into the second sample residual feature map corresponding to a scale of the first round; and where generating the second sample residual feature map for a round after the first round in the plurality of iteration rounds includes: generating an flipped sample residual feature map of the round by performing random flipping on a bit value in a sample residual feature map obtained in the previous round; generating a difference feature map of the round based on a difference between a difference feature map obtained in the previous round and an flipped sample residual feature map obtained in the previous round; and quantizing the difference feature map of the round into the second sample residual feature map corresponding to a scale of the round.

In some embodiments, the generation of the plurality of predicted residual feature maps is iteratively performed at the plurality of scales, and where generating the predicted residual feature map for a given scale of the plurality of scales includes: generating an flipped predicted feature map for the given scale based on flipped sample residual feature maps corresponding to the given scale and at least one scale before the given scale; and generating the predicted residual feature map for the given scale by inputting the sample text prompt and the flipped predicted feature map for the given scale into the machine learning model.

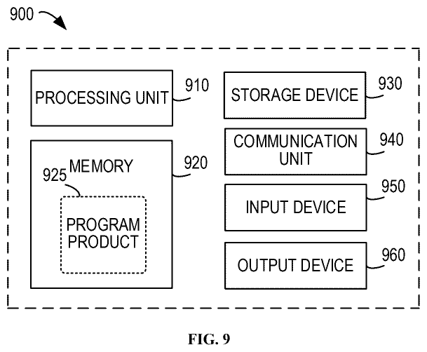

An embodiment of the present disclosure further provides a corresponding apparatus for implementing the above method or process. FIG. 8 shows an example structural block diagram of an apparatus 800 for image generation according to some embodiments of the present disclosure. The apparatus 800 may be implemented as or included in the electronic device 110. Each module/component in the apparatus 800 may be implemented by hardware, software, firmware, or any combination thereof.

As shown in FIG. 8, the apparatus 800 includes a feature embedding generation module 810 configured to generate a feature embedding by a trained machine learning model and based on at least a text prompt for image generation. The apparatus 800 further includes a visual feature unit determination module 820 configured to determine, by a trained classifier model, at least one visual feature unit from a visual feature codebook to form a visual feature map matching the feature embedding, where each visual feature unit in the visual feature codebook is indexed by a bit sequence, where determining each visual feature unit matching the generated feature embedding from the visual feature codebook includes: determining, by each classifier in the classifier model, a value of one bit position in the bit sequence respectively, and obtaining the visual feature unit from the visual feature codebook based on the determined value of the respective bit position in the bit sequence. The apparatus 800 further includes a predicted image generation module 830 configured to generate a predicted image matching the text prompt based on the visual feature map.

In some embodiments, the number of classifiers in the classifier model is the same as the number of bits of the bit sequence, and the classifiers respectively correspond to the respective bit positions in the bit sequence.

In some embodiments, the respective classifiers in the classifier model are configured to determine the values of the respective bit positions in the bit sequence in parallel.

In some embodiments, the generation of the feature embedding and the determination of the visual feature map are iteratively performed at a plurality of scales. For a given scale of the plurality of scales, the feature embedding generation module 810 is further configured to generate, by the machine learning model, the feature embedding for the given scale based on the text prompt and a visual feature map determined for at least one scale before the given scale. Determining the at least one visual feature unit for the given scale of the plurality of scales includes: determining, by the classifier model, a number of visual feature units corresponding to the given scale from the visual feature codebook, to obtain the visual feature map for the given scale.

In some embodiments, the visual feature map includes a plurality of residual feature maps of the plurality of scales. The predicted image generation module 830 is further configured to sample, based on a reference scale of the plurality of scales, the plurality of residual feature maps of the plurality of scales to the reference scale respectively, to obtain a plurality of sampled residual feature maps; generate a target feature map by aggregating the plurality of sampled residual feature maps; and decode the predicted image from the target feature map.

In some embodiments, the apparatus 800 further includes a model training module configured to obtain training data including a sample image and a sample text prompt describing the sample image; generate a plurality of sample residual feature maps of a plurality of scales by respectively performing random flipping on a bit value in a sample residual feature map of the sample image, the sample residual feature map includes binary bit values; generate a plurality of predicted residual feature maps of the plurality of scales based on a predetermined training objective by the machine learning model to be trained and the classifier model to be trained based on the sample text prompt; and train the machine learning model and the classifier model, the training objective is configured to reduce or minimize a difference between the plurality of sample residual feature maps and the plurality of predicted residual feature maps.

In some embodiments, the model training module is further configured to extract a sample feature map from the sample image; and quantize the sample feature map into a first sample residual feature map corresponding to a first scale of the plurality of scales.

An flipped sample residual feature map corresponding to the first scale is generated by performing random flipping on a bit value in the first sample residual feature map; and a second sample residual feature map corresponding to a scale other than the first scale in the plurality of scales is generated based on at least a difference between the sample feature map and the flipped sample residual feature map corresponding to the first scale.

In some embodiments, the generation of the second sample residual feature map is iteratively performed for other scales in the plurality of scales. For a first round of a plurality of iteration rounds, the model training module is further configured to generate a difference feature map based on the difference between the sample feature map and the flipped sample residual feature map corresponding to the first scale; and quantize the difference feature map into the second sample residual feature map corresponding to a scale of the first round. For a round after the first round in the plurality of iteration rounds, the generating the second sample residual feature map includes: generating an flipped sample residual feature map of the round by performing random flipping on a bit value in a sample residual feature map obtained in the previous round; generating a difference feature map of the round based on a difference between a difference feature map obtained in the previous round and an flipped sample residual feature map obtained in the previous round; and quantizing the difference feature map of the round into the second sample residual feature map corresponding to a scale of the round.

In some embodiments, the generation of the plurality of predicted residual feature maps is iteratively performed at the plurality of scales. For a given scale of the plurality of scales, the model training module is further configured to an flipped predicted feature map for the given scale based on flipped sample residual feature maps corresponding to the given scale and at least one scale before the given scale; and generate the predicted residual feature map for the given scale by inputting the sample text prompt and the flipped predicted feature map for the given scale into the machine learning model.

The units and/or modules included in the apparatus 800 may be implemented in various ways, including software, hardware, firmware, or any combination thereof. In some embodiments, one or more units and/or modules may be implemented using software and/or firmware, such as machine executable instructions stored on a storage medium. In addition to machine executable instructions or as an alternative, some or all units and/or modules in the apparatus 800 may be implemented at least partially by one or more hardware logic components. As an example, rather than a limitation, example types of hardware logic components that may be used include field programmable gate arrays (FPGAs), application specific integrated circuits (ASICs), application specific standard products (ASSPs), system on chips (SOCs), complex programmable logic devices (CPLDs), and so on.

It should be appreciated that one or more steps in the above method may be performed by a suitable electronic device or a combination of electronic devices. Such an electronic device or a combination of electronic devices may include, for example, the computing device 110 in FIG. 1.

FIG. 9 shows a block diagram of an electronic device 900 in which one or more embodiments of the present disclosure may be implemented. It should be appreciated that the electronic device 900 shown in FIG. 9 is only illustrative, without suggesting any limitation to the functions and scopes of the embodiments described herein. The electronic device 900 shown in FIG. 9 may be used to implement the computing device 110 in FIG. 1 or the apparatus 800 in FIG. 8.

As shown in FIG. 9, the electronic device 900 is in the form of a general electronic device. The components of the electronic device 900 may include, but are not limited to, one or more processors or processing units 910, a memory 920, a storage device 930, one or more communication units 940, one or more input devices 950, and one or more output devices 960. The processing unit 910 may be an actual or virtual processor, and may perform various processing based on the program stored in the memory 920. In a multi-processor system, a plurality of processing units executes computer executable instructions in parallel, to improve the parallel processing capability of the electronic device 900.

The electronic device 900 typically includes a plurality of computer storage medium. Such medium may be any available medium accessible to the electronic device 900, including, but not limited to, volatile and non-volatile medium, and removable and non-removable medium. The memory 920 may be volatile memory (for example, a register, cache, or a random access memory (RAM)), a non-volatile memory (such as a read-only memory (ROM), an electrically erasable programmable read-only memory (EEPROM), or a flash memory), or any combination thereof. The storage device 930 may be any removable or non-removable medium, and may include a machine-readable medium, such as a flash drive, a disk, or any other medium, which may be used to store information and/or data and may be accessed within the electronic device 900.

The electronic device 900 may further include other removable/non-removable, volatile/non-volatile memory medium. Although not shown in FIG. 9, a disk drive for reading from or writing into removable and non-volatile disks (such as a “floppy disk”), and an optical disk drive for reading from or writing into removable and non-volatile optical disks may be provided. In these cases, each drive may be connected to a bus (not shown) by one or more data medium interfaces. The memory 920 may include a computer program product 925 having one or more program modules configured to perform various methods or acts of the various embodiments of the present disclosure.

The communication unit 940 implements communication with another electronic device through the communication medium. In addition, the functions of the components of the electronic device 900 may be implemented by a single computing cluster or a plurality of computing machines, which may communicate through a communication connection. Therefore, the electronic device 900 may use a logical connection with one or more other servers, a network personal computer (PC), or another network node to operate in a networked environment.

The input device 950 may be one or more input devices, such as a mouse, a keyboard, a tracking ball, etc. The output device 960 may be one or more output devices, such as a display, a speaker, a printer, etc. The electronic device 900 may further communicate with one or more external devices (not shown), such as a storage device and a display device, through the communication unit 940 as needed, communicate with one or more devices that enable the user to interact with the electronic device 900, or communicate with any devices (such as a network card and a modem) that enable the electronic device 900 to communicate with one or more other electronic devices. Such communication may be performed via input/output (I/O) interfaces (not shown).

According to an example implementation of the present disclosure, a computer-readable storage medium is provided, having computer executable instructions stored thereon, where the computer executable instructions are executed by a processor to implement the method described above. According to an example implementation of the present disclosure, there is further provided a computer program product tangibly stored on a non-transitory computer-readable medium and including computer executable instructions, where the computer executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or another programmable data processing apparatus to produce a machine, such that the instructions, when executed by the processing unit of the computer or the another programmable data processing apparatus, produce an apparatus for implementing a function/act specified in one or more blocks of the flowcharts and/or block diagrams. These computer-readable program instructions may also be stored in a computer-readable storage medium, and the instructions cause a computer, a programmable data processing apparatus, and/or another device to operate in a specific manner, such that the computer-readable medium storing the instructions includes a manufactured product including instructions for implementing various aspects of the function/act specified in one or more blocks of the flowcharts and/or block diagrams.

The computer-readable program instructions may be loaded onto a computer, another programmable data processing apparatus, or another device, such that a series of operations and steps are performed on the computer, the another programmable data processing apparatus, or the another device, to produce a computer-implemented process, such that the instructions executed on the computer, the another programmable data processing apparatus, or the another device implement the function/act specified in one or more blocks of the flowcharts and/or block diagrams.

The flowcharts and block diagrams in the drawings show the possibly implemented architectures, functions, and operations of the system, the method, and the computer program product according to a plurality of implementations of the present disclosure. In this regard, each block in the flowchart or block diagram may represent a module, program segment, or part of an instruction, and the module, the program segment, or the part of the instruction contains one or more executable instructions for implementing the specified logical function. In some updated implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart, may be implemented by a special-purpose hardware-based system that executes a specified function or act, or may be implemented by a combination of special-purpose hardware and computer instructions.

The implementations of the present disclosure have been described above. The above description is illustrative, not exhaustive, and is not intended to limit the disclosed implementations. Without departing from the scope of the illustrated implementations, many modifications and changes will be apparent to those of ordinary skill in the art. The terms used herein are intended to best explain the principles, practical applications, or improvements to the technology in the market of the implementations, or to enable other persons of ordinary skill in the art to understand the implementations disclosed herein.

1. A method for image generation, comprising:
generating a feature embedding by a trained machine learning model and based on at least a text prompt for image generation;
determining, by a trained classifier model, at least one visual feature unit from a visual feature codebook to form a visual feature map matching the feature embedding, wherein each visual feature unit in the visual feature codebook is indexed by a bit sequence, and wherein determining each visual feature unit matching the generated feature embedding from the visual feature codebook comprises:
determining, by each classifier in the classifier model, a value of one bit position in the bit sequence respectively, and
obtaining the visual feature unit from the visual feature codebook based on the determined value of the respective bit position in the bit sequence; and
generating a predicted image matching the text prompt based on the visual feature map.

2. The method of claim 1, wherein the number of classifiers in the classifier model is the same as the number of bits of the bit sequence, and the classifiers respectively correspond to the respective bit positions in the bit sequence.

3. The method of claim 1, wherein the machine learning model and the classifier model are trained by:
obtaining training data comprising a sample image and a sample text prompt describing the sample image;
generating a plurality of sample residual feature maps of a plurality of scales by respectively performing random flipping on a bit value in a sample residual feature map of the sample image, the sample residual feature map comprising binary bit values;
generating a plurality of predicted residual feature maps of the plurality of scales based on the sample text prompt by the machine learning model to be trained and the classifier model to be trained; and
training the machine learning model and the classifier model based on a predetermined training objective, the training objective being configured to reduce or minimize a difference between the plurality of sample residual feature maps and the plurality of predicted residual feature maps.

4. The method of claim 3, wherein generating the plurality of sample residual feature maps comprises:
extracting a sample feature map from the sample image;
quantizing the sample feature map into a first sample residual feature map corresponding to a first scale of the plurality of scales;
generating an flipped sample residual feature map corresponding to the first scale by performing random flipping on a bit value in the first sample residual feature map; and
generating a second sample residual feature map corresponding to a scale other than the first scale in the plurality of scales based on at least a difference between the sample feature map and the flipped sample residual feature map corresponding to the first scale.

5. The method of claim 4, wherein the generation of the second sample residual feature map is iteratively performed for other scales in the plurality of scales, and wherein generating the second sample residual feature map for a first round of a plurality of iteration rounds comprises:
generating a difference feature map based on the difference between the sample feature map and the flipped sample residual feature map corresponding to the first scale; and
quantizing the difference feature map into the second sample residual feature map corresponding to a scale of the first round; and wherein generating the second sample residual feature map for a round after the first round in the plurality of iteration rounds comprises:
generating an flipped sample residual feature map of the round by performing random flipping on a bit value in a sample residual feature map obtained in the previous round;
generating a difference feature map of the round based on a difference between a difference feature map obtained in the previous round and an flipped sample residual feature map obtained in the previous round; and
quantizing the difference feature map of the round into the second sample residual feature map corresponding to a scale of the round.

6. The method of claim 3, wherein the generation of the plurality of predicted residual feature maps is iteratively performed at the plurality of scales, and wherein generating the predicted residual feature map for a given scale of the plurality of scales comprises:
generating an flipped predicted feature map for the given scale based on flipped sample residual feature maps corresponding to the given scale and at least one scale before the given scale; and
generating the predicted residual feature map for the given scale by inputting the sample text prompt and the flipped predicted feature map for the given scale into the machine learning model.

7. The method of claim 1, wherein the respective classifiers in the classifier model are configured to determine the values of the respective bit positions in the bit sequence in parallel.

8. The method of claim 1, wherein the generation of the feature embedding and the determination of the visual feature map are iteratively performed at a plurality of scales, and wherein generating the feature embedding for a given scale of the plurality of scales comprises:
generating, by the machine learning model, the feature embedding for the given scale based on the text prompt and a visual feature map determined for at least one scale before the given scale; and
wherein determining the at least one visual feature unit for the given scale of the plurality of scales comprises:
determining, by the classifier model, a number of visual feature units corresponding to the given scale from the visual feature codebook to obtain the visual feature map for the given scale.

9. The method of claim 1, wherein the visual feature map comprises a plurality of residual feature maps of a plurality of scales, and generating the predicted image matching the text prompt comprises:
sampling, based on a reference scale of the plurality of scales, the plurality of residual feature maps of the plurality of scales to the reference scale respectively, to obtain a plurality of sampled residual feature maps;
generating a target feature map by aggregating the plurality of sampled residual feature maps; and
decoding the predicted image from the target feature map.

10. An electronic device, comprising:
at least one processor; and
at least one memory coupled to the at least one processor and storing instructions executable by the at least one processor, the instructions, when executed by the at least one processor, causing the device to perform acts comprising:
generating a feature embedding by a trained machine learning model and based on at least a text prompt for image generation;
determining, by a trained classifier model, at least one visual feature unit from a visual feature codebook to form a visual feature map matching the feature embedding, wherein each visual feature unit in the visual feature codebook is indexed by a bit sequence, and wherein determining each visual feature unit matching the generated feature embedding from the visual feature codebook comprises:
determining, by each classifier in the classifier model, a value of one bit position in the bit sequence respectively, and
obtaining the visual feature unit from the visual feature codebook based on the determined value of the respective bit position in the bit sequence; and
generating a predicted image matching the text prompt based on the visual feature map.

11. The electronic device of claim 10, wherein the number of classifiers in the classifier model is the same as the number of bits of the bit sequence, and the classifiers respectively correspond to the respective bit positions in the bit sequence.

12. The electronic device of claim 10, wherein the machine learning model and the classifier model are trained by:
obtaining training data comprising a sample image and a sample text prompt describing the sample image;
generating a plurality of sample residual feature maps of a plurality of scales by respectively performing random flipping on a bit value in a sample residual feature map of the sample image, the sample residual feature map comprising binary bit values;
generating a plurality of predicted residual feature maps of the plurality of scales based on the sample text prompt by the machine learning model to be trained and the classifier model to be trained; and
training the machine learning model and the classifier model based on a predetermined training objective, the training objective being configured to reduce or minimize a difference between the plurality of sample residual feature maps and the plurality of predicted residual feature maps.

13. The electronic device of claim 12, wherein generating the plurality of sample residual feature maps comprises:
extracting a sample feature map from the sample image;
quantizing the sample feature map into a first sample residual feature map corresponding to a first scale of the plurality of scales;
generating an flipped sample residual feature map corresponding to the first scale by performing random flipping on a bit value in the first sample residual feature map; and
generating a second sample residual feature map corresponding to a scale other than the first scale in the plurality of scales based on at least a difference between the sample feature map and the flipped sample residual feature map corresponding to the first scale.

14. The electronic device of claim 13, wherein the generation of the second sample residual feature map is iteratively performed for other scales in the plurality of scales, and wherein generating the second sample residual feature map for a first round of a plurality of iteration rounds comprises:
generating a difference feature map based on the difference between the sample feature map and the flipped sample residual feature map corresponding to the first scale; and
quantizing the difference feature map into the second sample residual feature map corresponding to a scale of the first round; and wherein generating the second sample residual feature map for a round after the first round in the plurality of iteration rounds comprises:
generating an flipped sample residual feature map of the round by performing random flipping on a bit value in a sample residual feature map obtained in the previous round;
generating a difference feature map of the round based on a difference between a difference feature map obtained in the previous round and an flipped sample residual feature map obtained in the previous round; and
quantizing the difference feature map of the round into the second sample residual feature map corresponding to a scale of the round.

15. The electronic device of claim 12, wherein the generation of the plurality of predicted residual feature maps is iteratively performed at the plurality of scales, and wherein generating the predicted residual feature map for a given scale of the plurality of scales comprises:
generating an flipped predicted feature map for the given scale based on flipped sample residual feature maps corresponding to the given scale and at least one scale before the given scale; and
generating the predicted residual feature map for the given scale by inputting the sample text prompt and the flipped predicted feature map for the given scale into the machine learning model.

16. The electronic device of claim 10, wherein the respective classifiers in the classifier model are configured to determine the values of the respective bit positions in the bit sequence in parallel.

17. The electronic device of claim 10, wherein the generation of the feature embedding and the determination of the visual feature map are iteratively performed at a plurality of scales, and wherein generating the feature embedding for a given scale of the plurality of scales comprises:
generating, by the machine learning model, the feature embedding for the given scale based on the text prompt and a visual feature map determined for at least one scale before the given scale; and
wherein determining the at least one visual feature unit for the given scale of the plurality of scales comprises:
determining, by the classifier model, a number of visual feature units corresponding to the given scale from the visual feature codebook to obtain the visual feature map for the given scale.

18. The electronic device of claim 10, wherein the visual feature map comprises a plurality of residual feature maps of a plurality of scales, and generating the predicted image matching the text prompt comprises:
sampling, based on a reference scale of the plurality of scales, the plurality of residual feature maps of the plurality of scales to the reference scale respectively, to obtain a plurality of sampled residual feature maps;
generating a target feature map by aggregating the plurality of sampled residual feature maps; and
decoding the predicted image from the target feature map.

19. A non-transitory computer-readable storage medium having a computer program stored thereon, the computer program, when executed by a processor, causing the processor to perform acts comprising:
generating a feature embedding by a trained machine learning model and based on at least a text prompt for image generation;
determining, by a trained classifier model, at least one visual feature unit from a visual feature codebook to form a visual feature map matching the feature embedding, wherein each visual feature unit in the visual feature codebook is indexed by a bit sequence, and wherein determining each visual feature unit matching the generated feature embedding from the visual feature codebook comprises:
determining, by each classifier in the classifier model, a value of one bit position in the bit sequence respectively, and
obtaining the visual feature unit from the visual feature codebook based on the determined value of the respective bit position in the bit sequence; and
generating a predicted image matching the text prompt based on the visual feature map.

20. The non-transitory computer-readable storage medium of claim 19, wherein the number of classifiers in the classifier model is the same as the number of bits of the bit sequence, and the classifiers respectively correspond to the respective bit positions in the bit sequence.
